(19) United States
(12) Patent Application Publication
(10) Pub. No.: US 2026/0218818 A1
(43) Pub. Date: Jul. 30, 2026

(54) PIPES INCLUDING HIGH DENSITY MULTIMODAL POLYETHYLENE COMPOSITIONS

(71) Applicant: Dow Global Technologies LLC, Midway, MI (US)

(72) Inventors: Elva L. Lugo, Manvel, TX (US); Andrew T. Heitsch, Angleton, TX (US); Todd A. Hogan, Midland, MI (US); Rachel C. Anderson, Midland, MI (US); Joel D. Wieliczko, South Charleston, WV (US); Paul Balding, Lake Jackson, TX (US); Rujul Mehta, Manvel, TX (US)

(21) Appl. No.: 19/148,757

(22) PCT Filed: Mar. 12, 2024
(86) PCT No.: PCT/US2024/019537

§ 371 Date: Jul. 17, 2025

Related U.S. Application Data
(60) Provisional application No. 63/497,118, filed on Apr. 19, 2023.

(51) Int. Cl. F16L 9/12; B29C 48/09; B29K 23/00; B29L 23/00; C08F 2/34; C08F 4/6192; C08F 210/16

(52) U.S. Cl. CPC F16L 9/12; B29C 48/09; C08F 2/34; C08F 4/61925; C08F 210/16; B29K 2023/065; B29L 2023/22; C08F 2420/00

(57) ABSTRACT

The present invention relates to a pipe including a multimodal high density polyethylene composition, as well as processes for making the pipe. The multimodal high density polyethylene composition includes a high molecular weight component and a low molecular weight component and can be made in a single reactor. The combination of properties of the composition deliver a desirable balance of ESCR, flexibility, and stiffness particularly suitable for pipe such as conduit and pressure-less pipe applications.

### FIELD

The present invention relates to pipes including multimodal polyethylene compositions and methods for making the same.

### INTRODUCTION

Polyethylene compositions can be formed into useful articles using molding and extrusion processes. Such articles include containers, films, and pipes. When extruding polyethylene compositions, it is generally desirable for the polyethylene compositions to have a lower molecular weight and lower viscosity, particularly under shear conditions that occur when forming pipes, so that the polyethylene compositions can be more easily processed. However, polyethylene compositions having a lower molecular weight do not achieve a desirable balance of environmental stress crack resistance (ESCR) and stiffness necessary for pipe applications, as a lower melt viscosity and/or higher density (e.g., greater than 0.935 g/cc) can lead to undesirable ESCR.

Attempts to achieve a desirable balance of stiffness and ESCR include the introduction of narrow molecular weight distribution catalysts in dual reactor systems to produce multimodal polyethylene compositions. With multimodal compositions in dual reactor systems, it is possible to increase stress crack resistance by increasing the molecular weight or increasing the comonomer content of the high molecular weight fraction, which in turn decreases density. However, altering the higher molecular fraction can increase viscosity and lower stiffness, and producing multimodal compositions in a dual or multiple reactor system can be cost prohibitive and less sustainable. Accordingly, there remains a need for pipes comprising multimodal high density polyethylene compositions that can be produced in a single reactor, can be more easily processed, and can provide a desirable balance of properties such as flexibility, stiffness, and ESCR.

### SUMMARY

The present invention provides a pipe comprising a multimodal high density polyethylene composition, as well as a process for making pipes comprising the multimodal high density polyethylene composition. The multimodal high density polyethylene, in some embodiments, can provide a melt index and shear thinning behavior that aids processibility while maintaining a balance of desirable physical properties for forming pipes.

In a first aspect, the present invention relates to a pipe comprising a multimodal high density polyethylene composition. In some embodiments, the multimodal high density polyethylene composition comprises greater than 40 wt. % of a high molecular weight component and less than 60 wt. % of a low molecular weight component, based on the total weight of the multimodal polyethylene composition, wherein the multimodal polyethylene composition has:
a. a density greater than 0.950 g/cm³;
b. a high load melt index (I₂₁) of from 20.0 to 35.0 g/10 min;
c. a viscosity at 0.1 rad/sec of greater than 30,000 Pas;
d. a shear thinning ratio of from 15.0 to 25.0;
e. a strain hardening modulus of greater than 30.00 MPa;
f. a PENT value greater than 30 hours; and
g. a Mz/Mw of greater than 5.5.

In a second aspect, the present invention relates to a process for making a pipe comprising the composition according to embodiments of the first aspect. In some embodiments, the process for making a pipe comprises forming a multimodal high density polyethylene composition according to embodiments disclosed herein and extruding the multimodal high density polyethylene composition to form a pipe, wherein the multimodal high density polyethylene is formed by polymerizing ethylene monomer and an alpha-olefin comonomer in the presence of a bimodal catalyst system in a single gas phase polymerization (GPP); wherein the bimodal catalyst system consists essentially of a metallocene catalyst, a single-site non-metallocene catalyst that is a bis((alkyl-substituted phenylamido)ethyl)amine catalyst, optionally a host material, and optionally an activator; wherein the host material, when present, is selected from at least one of an inert hydrocarbon liquid and a solid support; wherein the metallocene catalyst is an activation reaction product of contacting an activator with a metal-ligand complex of formula (R₁₋₂Cp)((alkyl)₁₋₃Indenyl)MX₂, wherein R is hydrogen, methyl, or ethyl; each alkyl independently is a (C₁-C₄)alkyl; M is titanium, zirconium, or hafnium; and each X is independently a halide, a (C₁ to C₂₀)alkyl, a (C₇ to C₂₀)aralkyl, a (C₁ to C₆)alkyl-substituted (C₆ to C₁₂)aryl, or a (C₁ to C₆)alkyl-substituted benzyl; and wherein the bis((alkyl-substituted phenylamido)ethyl)amine catalyst is an activation reaction product of contacting an activator with a bis((alkyl-substituted phenylamido)ethyl)amine ZrR¹₂, wherein each R₁ is independently selected from F, Cl, Br, I, benzyl, —CH₂Si(CH₃)₃, a (C₁-C₅)alkyl, and a (C₂-C₅)alkenyl.

These and other embodiments are described in more detail in the Detailed Description.

### BRIEF DESCRIPTION OF THE DRAWINGS

FIG. 1 is an Absolute GPC chromatogram of inventive and comparative examples described below.

### DETAILED DESCRIPTION

Unless stated to the contrary, implicit from the context, or customary in the art, all parts and percentages are based on weight, all temperatures are in ° C., and all test methods are current as of the filing date of this disclosure.

The term “composition,” as used herein, refers to a mixture of materials which comprises the composition, as well as reaction products and decomposition products formed from the materials of the composition.

The term “polymer” means a polymeric compound prepared by polymerizing monomers, whether of the same or a different type. The generic term polymer thus embraces the term homopolymer as defined hereafter, and the term interpolymer as defined hereinafter. Trace amounts of impurities (for example, catalyst residues) may be incorporated into and/or within the polymer. A polymer may be a single polymer, a polymer blend or a polymer mixture, including mixtures of polymers that are formed in situ during polymerization.

The term “homopolymer,” as used herein, refers to polymers prepared from only one type of monomer with the understanding that trace amounts of impurities can be incorporated into the polymer structure.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

The term, “ethylene/α-olefin interpolymer,” as used herein, refers to an interpolymer that comprises, in polymerized form, a majority amount (>50 mol %) of units derived from ethylene monomer, and the remaining units derived from one or more α-olefins. Typical α-olefins used in forming ethylene/α-olefin interpolymers are C₃-C₁₀ alkenes.

The term, “ethylene/α-olefin copolymer,” as used herein, refers to a copolymer that comprises, in polymerized form, a majority amount (>50 mol %) of ethylene monomer, and an α-olefin, as the only two monomer types.

The term “alpha-olefin” or “α-olefin”, as used herein, refers to an alkene having a double bond at the primary or alpha (α) position.

“Polyethylene” or “ethylene-based polymer” shall mean polymers comprising a majority amount (>50 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); single-site catalyzed Linear Low Density Polyethylene, including both linear and substantially linear low density resins (m-LLDPE); ethylene-based plastomers (POP) and ethylene-based elastomers (POE); Medium Density Polyethylene (MDPE); and High Density Polyethylene (HDPE).

The term “HDPE” refers to polyethylenes having densities greater than about 0.935 g/cm³ and up to about 0.980 g/cm³, which are generally prepared with Ziegler-Natta catalysts, chrome catalysts or single-site catalysts including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy).

The term “multimodal” means compositions that can be characterized by having at least two (2) polymer components or subcomponents with different molecular weights and/or different comonomer contents. In one embodiment, multimodal may be defined by having at least two distinct peaks in an Absolute Gel Permeation Chromatography (GPC) chromatogram showing the molecular weight distribution of the composition. The term “bimodal” means compositions that can be characterized by having two (2) polymer components or subcomponents with different molecular weights and/or different comonomer contents. In one embodiment, bimodal may be defined by having two distinct peaks in a Absolute Gel Permeation Chromatography (GPC) chromatogram showing the molecular weight distribution of the composition. All GPC measurement values (e.g., Mw, Mn, Mz) recited herein are Absolute GPC measurements provided in accordance with the test methods described below. A person of ordinary skill in the art understands the difference between Absolute GPC and Convention GPC measurements.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The pipe disclosed herein comprises a multimodal high density polyethylene composition. The composition according to embodiments disclosed herein comprises a high molecular weight (HMW) component and a low molecular weight (LMW) component. “High molecular weight” means the HMW component is calculated to have a higher molecular weight than the LMW component, and “lower molecular weight” means that the LMW component is calculated to have a lower molecular weight than the HMW component. The composition is multimodal. In some embodiments, the composition is bimodal and consist of a HMW component and a LMW component.

The HMW component is a copolymer of ethylene and one or more alpha-olefin comonomers. The LMW component is also a copolymer of ethylene and one or more alpha-olefin comonomers. The alpha-olefin comonomers can have 3 to 10 carbon atoms or 3 to 8 carbon atoms. Exemplary alpha-olefin comonomers include, but are not limited to, propylene, 1-butene, 1-pentene, 1-hexene, 1-heptene, 1-octene, 1-nonene, 1-decene, and 4-methyl-1-pentene. In some embodiments, the alpha-olefin comonomers may be selected from the group consisting of 1-butene, 1-hexene, and 1-octene, or from the group consisting of 1-butene and 1-hexene, or from the group consisting of 1-hexene or 1-octene. In some embodiments, the HMW component is a non-metallocene catalyzed ethylene copolymer. In some embodiments, the LMW component is a metallocene catalyzed ethylene copolymer. As discussed below, the HMW component and LMW component can be polymerized in a single reactor in the presence of bimodal catalyst system.

The multimodal high density polyethylene composition comprises greater than 40 wt. % of a high molecular weight component and less than 60 wt. % of a low molecular weight component. The multimodal high density polyethylene composition may comprise greater than 40 wt. %, greater than 42 wt. %, greater than 45 wt. %, greater than 46 wt. %, or greater than 47 wt. % of the HMW component, or from 40 to 60 wt. %, or from 45 to 55 wt. %, or from 47 to 53 wt. % of the HMW component, based on the total weight of the composition. The multimodal high density polyethylene composition may comprise less than 60 wt. %, less than 55 wt. %, less than 54 wt. % or less than 53 wt. % of the LMW component, or from 40 to 60 wt. %, or from 45 to 55 wt. %, or from 47 to 53 wt. % of the LMW component, based on the total weight of the composition. Without being bound by theory, it is believed the concentration of the HMW component in the composition contributes to toughness and helps deliver short chain branching that promotes chain entanglement and improves properties such as slow crack growth.

In some embodiments, the HMW component has a Mw of from 300,000 g/mol to 400,000 g/mol, a Mn of 80,000 to 120,000 g/mol, a Mz of 900,000 to 1,000,000 g/mol, or an Mw/Mn of 2.0 to 5.5, when measured according to the test methods below. In some embodiments, the LMW component has a Mw of from 10,000 to 30,000 g/mol, a Mn of 3,000 to 7,000 g/mol, a Mz of 20,000 to 90,000, or a Mw/Mn of 2.5 to 5.0, when measured according to the test methods below.

The multimodal high density polyethylene composition has a density greater than 0.950 g/cm³. In some embodiments, the multimodal high density polyethylene composition can have a density greater than 0.951 g/cm³ or greater than 0.952 g/cm³ or from 0.950 g/cm³ to 0.960 g/cm³, or from 0.951 to 0.957 g/cm³, or from 0.952 to 0.955 g/cm³.

The multimodal high density polyethylene composition has a high load melt index (I₂₁) of from 20.0 to 35.0 g/10 min. In some embodiments, the multimodal high density polyethylene composition has a high load melt index (I₂₁) of from 21.0 to 33.0 g/10 min, from 23.0 g/10 min to 33.0 g/10 min, from 27.0 to 31.0 g/10 min.

The multimodal high density polyethylene composition has a complex viscosity at 190° C. and 0.1 radians per second (rad/sec) of greater than 30,000 Pascal-seconds (Pas). In some embodiments, the viscosity at 190° C. and 0.1 rad/sec can be greater than 31,000 Pas, greater than 32,000 Pas, greater than 40,000 Pas, or from 30,000 Pas to 50,000 Pas.

The multimodal high density polyethylene composition has a shear thinning index of from 15.0 to 25.0. The term “shear thinning index” refers to a ratio of a complex viscosity of a polymer at a frequency of 0.1 rad/sec to a ratio of complex viscosity of the polymer at a frequency of 100 rad/sec. All individual values and subranges of from 15.0 to 25.0 are disclosed and included herein. For example, in some embodiments, the multimodal high density polyethylene composition has a shear thinning index of from 17.0 to 24.0, from 18.0 to 23.0, from 19.0 to 22.0, or from 20.0 to 21.0. The shear thinning index in the specified range contributes to improved processability for manufacturing pipes having desirable properties such as toughness and stiffness.

The multimodal high density polyethylene composition has a PENT value greater than 30 hours. In some embodiments, the multimodal high density polyethylene has a PENT value greater than 40 hours, greater than 45 hours, greater than 50 hours, greater than 60 hours, greater than 100 hours, greater than 200 hours, greater than 300 hours, greater than 400 hours, greater than 500 hours, or greater than 600 hours.

The multimodal high density polyethylene composition has a Mz/Mw of greater than 5.5. In some embodiments, the multimodal high density polyethylene composition has a Mz/Mw of greater than 5.7, or greater than 6.0.

In some embodiments, the multimodal high density polyethylene composition has a molecular weight distribution from Absolute GPC, where the Absolute GPC molecular weight distribution has a first peak, a local minimum, and a second peak in a range of Log (molecular weight) of 3.5 to 6.0, wherein the local minimum is an inflection point between the first peak and the second peak, and the first peak corresponds to the low molecular weight component and the second peak corresponds to the high molecular weight component. Within this range of Log (molecular weight) of 3.5 to 6.0, a first and then second derivative of the equally spaced data produces three inflexion points for a bimodal molecular weight distribution. Two positive inflexion points, derivative values going from positive to negative values as Log (molecular weight) increases, and one negative inflexion point, derivative values going from negative to positive as Log (molecular weight) increases. The local minimum is located between the first peak and the second peak. The first peak, which cab be designated as the local maximum (Mmax1), is the molecular weight at the inflexion point that corresponds to the low molecular weight component and the second peak, which can be designated as the local maximum (Mmax2), is the molecular weight at the inflexion point that corresponds to the high molecular weight component. The local minimum is the lowest molecular weight value between the first peak and the second peak and is the negative inflection point between the first peak and the second peak. A person of ordinary skill in the art understands that the GPC chromatogram relates to the molecular architecture of the multimodal high density polyethylene composition and is in part a result of the particular catalyst system used to form the composition. It has been found that, according to embodiments disclosed herein, a particular type of catalyst is suitable for producing the multimodal high density polyethylene composition in a single reactor and, relatedly, delivering a specific GPC chromatogram, whereas prior art compositions with similar features or different catalyst systems cannot be made in a single reactor system, deliver the specific GPC chromatogram, and/or deliver the desirable properties disclosed herein. In some embodiments, the Absolute GPC chromatogram has a first peak, a local minimum, and a second peak in a range of Log (molecular weight) of from 3.5 to 5.8 or from 3.5 to 5.5.

The multimodal high density polyethylene composition has a strain hardening modulus of greater than 30.00 MPa, or greater than 32.00 MPa, or greater than 34.00 MPa, or greater than 38.00 MPa, or greater than 44.00 MPa, or greater than 48.00 MPa. In some embodiments, the strain hardening modulus is less than 70.00 MPa, less than 60.00 MPa, or less than 55.00 MPa. Without being bound by theory, it is believed the strain hardening modulus is related to the amount of chain entanglement in the composition, which in turn delivers desirable mechanical properties such as PENT and ESCR.

In some embodiments, the multimodal high density polyethylene composition has an I₂₁/I₅ ratio of from 25 to 35. All individual values and subranges of from 25 to 35 are disclosed and included herein. For example, the multimodal high density polyethylene composition can have an I₂₁/I₅ ratio of from 25 to 35, from 25 to 33, from 25 to 31. In some embodiments, the multimodal polyethylene composition has a melt index (I₅) of from 0.50 to 1.50 g/10 min, or from 0.60 to 1.30 g/10 min, or from 0.70 to 1.20 g/10 min.

In some embodiments, the multimodal high density polyethylene composition has a metal catalyst residual of at least 0.2 ppm by combined weight of at least zirconium, titanium, and/or hafnium per one million parts of the composition. In some embodiments, the multimodal high density polyethylene composition has a metal catalyst residual of at least 0.2 ppm zirconium per one million parts of the composition.

In some embodiments, the multimodal high density polyethylene composition has a weight average molecular weight (Mw) of greater than 175,000 g/mol, or greater than 180,000 g/mol, or greater than 190,000 g/mol, or greater than 200,000 g/mol. In some embodiments, the multimodal high density polyethylene composition has a melt index (I₂) of from 0.20 to 0.40 g/10 min, or from 0.22 to 0.38 g/10 min, or from 0.24 to 0.36 g/10 min, or from 0.26 to 0.34 g/10 min. In some embodiments, the multimodal high density polyethylene composition has a I₂₁/I₂ ratio of from 90 to 110 or from 95 to 105. In some embodiments, the multimodal high density polyethylene composition has a molecular weight distribution (Mw/Mn) of greater than 20.0, or from 10.0 to 30.0, or from 15.0 to 25.0, or from 20.0 to 25.0, or from 20.0 30.0.

In some embodiments, the multimodal high density polyethylene composition has a secant modulus at 2% of greater than 130 ksi (896 MPa). In some embodiments, the multimodal high density polyethylene composition has an ESCR value of greater than 1,000 hours.

The multimodal high density polyethylene composition of the present invention is suitable for fabrication of pipe. In some embodiments, the pipe is a conduit pipe or pressure-less pipe. Conduit pipes must meet or exceed D3350 cell classification PE224420C/E. The features of the multimodal high density polyethylene composition, including its density and melt index properties, contribute to making it particularly suitable for conduit or pressure-less pipes. The pipe may be extruded by methods known to those skilled in the art. The pipe may be a monolayer pipe and may comprise suitable additives used for pipe applications. Such additives include colorants and materials suitable to protect the composition from adverse environmental effect, for example, oxidation during extrusion or degradation under service conditions. Suitable additives include process stabilizers, antioxidants, pigments, metal de-activators, additives to improve chlorine resistance, and UV. In some embodiments, the pipe be a multilayer composite pipe including metal/plastic may composite pipes and pipes comprising one or more (e.g., one or two) layers, and where at least one layer comprises the composition according to the present invention. The pipe according to embodiments herein may meet hydrostatic testing requirements known in the industry and to those skilled in the art. For example, in some embodiments, the pipe can exhibit a hydrostatic performance of 1,600 psi at 23° C. in accordance with ASTM D1598 of greater than 1,000 hour.

The process for making a pipe comprises forming a multimodal high density polyethylene composition according to embodiments disclosed herein and extruding the multimodal high density polyethylene composition to form a pipe, wherein the multimodal high density polyethylene is formed by polymerizing ethylene monomer and an alpha-olefin comonomer in the presence of a bimodal catalyst system in a single gas phase polymerization (GPP); wherein the bimodal catalyst system consists essentially of a metallocene catalyst, a single-site non-metallocene catalyst that is a bis((alkyl-substituted phenylamido)ethyl)amine catalyst, optionally a host material, and optionally an activator; wherein the host material, when present, is selected from at least one of an inert hydrocarbon liquid and a solid support; wherein the metallocene catalyst is an activation reaction product of contacting an activator with a metal-ligand complex of formula (R₁₋₂Cp)((alkyl)₁₋₃Indenyl)MX₂, wherein R is hydrogen, methyl, or ethyl; each alkyl independently is a (C₁-C₄)alkyl; M is titanium, zirconium, or hafnium; and each X is independently a halide, a (C₁ to C₂₀)alkyl, a (C₇ to C₂₀)aralkyl, a (C₁ to C₆)alkyl-substituted (C₆ to C₁₂)aryl, or a (C₁ to C₆)alkyl-substituted benzyl; and wherein the bis((alkyl-substituted phenylamido)ethyl)amine catalyst is an activation reaction product of contacting an activator with a bis((alkyl-substituted phenylamido)ethyl)amine ZrR¹₂, wherein each R¹ is independently selected from F, Cl, Br, I, benzyl, —CH₂Si(CH₃)₃, a (C₁-C₅)alkyl, and a (C₂-C₅)alkenyl. In some embodiments the metal-ligand complex of formula (I) is a compound wherein M is zirconium (Zr); R is H, alternatively methyl, alternatively ethyl; and each X is C₁, methyl, or benzyl; and the bis((alkyl-substituted phenylamido)ethyl)amine MR12 is a bis(2-(pentamethylphenylamido)ethyl)-amine zirconium complex of formula (II):

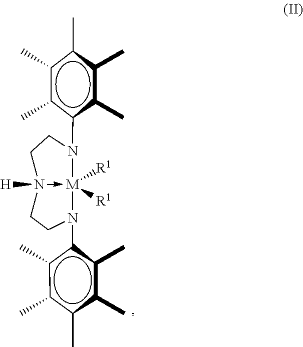

wherein M is Zr and each R¹ independently is C₁, Br, a (C₁ to C₂₀)alkyl, a (C₁ to C₆)alkyl-substituted (C₆-C₁₂)aryl, benzyl, or a (C₁ to C₆)alkyl-substituted benzyl. In some aspects the compound of formula (II) is bis(2-(pentamethylphenylamido)ethyl)-amine zirconium dibenzyl. In some embodiments each X and R1 is independently C₁, methyl, 2,2-dimethylpropyl, —CH₂Si(CH₃)₃, or benzyl. In some embodiments the metal-ligand complex of formula (I) is (cyclopentadienyl) (1,5-dimethylindenyl) zirconium dimethyl. In some embodiments the metal-ligand complex of formula (I) is (methylcyclopentadienyl) (1,3-dimethyl-4,5,6,7-tetrahydroindenyl) zirconium dimethyl.

### Process for Making the Multimodal Composition

In some embodiments, the composition is made by polymerizing ethylene and an alpha-olefin in the presence of a bimodal catalyst system in a single gas phase polymerization (GPP); wherein the bimodal catalyst system consists essentially of a metallocene catalyst, a single-site non-metallocene catalyst that is a bis((alkyl-substituted phenylamido)ethyl)amine catalyst, optionally a host material, and optionally an activator; wherein the host material, when present, is selected from at least one of an inert hydrocarbon liquid and a solid support; wherein the metallocene catalyst is an activation reaction product of contacting an activator with a metal-ligand complex of formula (R₁₋₂Cp)((alkyl)₁₋₃Indenyl)MX₂, wherein R is hydrogen, methyl, or ethyl; each alkyl independently is a (C₁-C₄)alkyl; M is titanium, zirconium, or hafnium; and each X is independently a halide, a (C₁ to C₂₀)alkyl, a (C₇ to C₂₀)aralkyl, a (C₁ to C₆)alkyl-substituted (C₆ to C₁₂)aryl, or a (C₁ to C₆)alkyl-substituted benzyl; and wherein the bis((alkyl-substituted phenylamido)ethyl)amine catalyst is an activation reaction product of contacting an activator with a bis((alkyl-substituted phenylamido)ethyl)amine ZrR¹₂, wherein each R¹ is independently selected from F, Cl, Br, I, benzyl, —CH₂Si(CH₃)₃, a (C₁-C₅)alkyl, and a (C₂-C₅)alkenyl.

In some embodiments, the multimodal high density polyethylene composition may be a polymerized reaction product of an ethylene monomer and at least one C₃-C₁₂ alpha-olefin comonomer. For example, embodiments of the composition may be a polymerized reaction product of an ethylene monomer and 1-butene, 1-hexene, or both. Alternatively, embodiments of the bimodal polyethylene composition may be a polymerized reaction product of an ethylene monomer and 1-butene, 1-octene, or both. Embodiments of the bimodal polyethylene may also be a polymerized reaction product of an ethylene monomer and 1-hexene, 1-octene, or both. In some embodiments, the C₃-C₁₂ alpha-olefin comonomer may not be propylene.

In some embodiments, the bimodal polyethylene may be produced with a catalyst system in a single reactor. As used herein, a “catalyst system” may comprise a main catalyst, a trim catalyst, and, optionally, at least one activator. Catalyst systems may also include other components, such as supports, and are not limited to a main catalyst, a trim catalyst, and, optionally, at least one activator. Embodiments of the catalyst system may comprise a main catalyst and a metallocene trim catalyst. Embodiments of the catalyst system may also comprise one or more additives commonly used in the art of olefin polymerization. For example, embodiments of the catalyst system may comprise one or more continuity additives, flow aids, and anti-static aids. In embodiments, the reactor may be a gas phase reactor, although slurry phase reactors may also be used.

Embodiments of the catalyst system may comprise at least one catalyst for producing a high molecular weight fraction of the bimodal polyethylene by polymerization (sometimes referred to herein as an “HMW catalyst”), and at least one catalyst compound for producing a low molecular weight fraction of the bimodal polyethylene by polymerization (sometimes referred to herein as an “LMW catalyst”).

Embodiments of the catalyst system may be referred to as a “bimodal catalyst system.” Such a catalyst system produces a bimodal polyethylene composition having separate, identifiable high molecular weight and low molecular weight distributions. The term “bimodal catalyst system” may comprise any formulation, mixture, or system that comprises at least two different catalyst compounds, each having the same or a different metal group, but generally different ligands or catalyst structure, including a “dual catalyst.” Alternatively, each different catalyst compound of the bimodal catalyst system resides on a single support particle, in which case a dual catalyst is considered to be a supported catalyst. However, the term “bimodal catalyst system” also broadly comprises a system or mixture in which one of the catalysts resides on one collection of support particles, and another catalyst resides on another collection of support particles. In such embodiments, the two supported catalysts are introduced to a single reactor, either simultaneously or sequentially, and polymerization is conducted in the presence of the two collections of supported catalysts. Alternatively, the bimodal catalyst system may comprise a mixture of unsupported catalysts in slurry form.

The single gas phase polymerization reactor may be a fluidized-bed gas phase polymerization (FB-GPP) reactor and the effective polymerization conditions may comprise conditions (a) to (e): (a) the FB-GPP reactor having a fluidized resin bed at a bed temperature from 80 to 110 degrees Celsius (° C.), alternatively from 85 to 108° C., alternatively from 90 to 108° C., alternatively from 94 to 107° C., alternatively from 103° C. to 106° C.; (b) the FB-GPP reactor receiving feeds of respective independently controlled amounts of ethylene, 1-alkene characterized by a 1-alkene-to-ethylene (C_{X}/C₂) molar ratio, the bimodal catalyst system, optionally a trim catalyst comprising a solution in an inert hydrocarbon liquid of a dissolved amount of unsupported form of the metallocene catalyst made from the metal-ligand complex of formula (I) and activator, optionally hydrogen gas (H₂) characterized by a hydrogen-to-ethylene (H₂/C₂) molar ratio or by a weight parts per million H₂ to mole percent C₂ ratio (H₂ ppm/C₂ mol %), and optionally an induced condensing agent (ICA) comprising a (C₅-C₁₀)alkane(s), e.g., isopentane; wherein the (C₆/C₂) molar ratio is from 0.0001 to 0.1, alternatively from 0.001 to 0.01; wherein when H₂ is fed, the H₂/C₂ molar ratio is from 0.0001 to 2.0, alternatively from 0.0030 to 0.0060, or the H₂ ppm/C₂ mol % ratio is from 1 to 20,000, alternatively from 30.0 to 60.0; and wherein when the ICA is fed, the concentration of ICA in the reactor is from 1 to 20 mole percent (mol %), alternatively from 7 to 16 mol %, based on total moles of ethylene, 1-alkene, and ICA in the reactor. The average residence time of the copolymer in the reactor may be from 1 to 6 hours, alternatively from 2 to 4 hours. A continuity additive may be used in the FB-GPP reactor during polymerization.

The bimodal catalyst system may be characterized by an inverse response to bed temperature such that when the bed temperature is increased, the viscoelastic property value of the resulting composition is decreased, and when the bed temperature is decreased, the viscoelastic property value of the resulting bimodal poly(ethylene-co-1-alkene) copolymer is increased. The bimodal catalyst system may be characterized by an inverse response to the H₂/C₂ ratio such that when the H₂/C₂ ratio is increased, the viscoelastic property value of the resulting bimodal poly(ethylene-co-1-alkene) copolymer is decreased, and when the H₂/C₂ ratio is decreased, the viscoelastic property value of the resulting composition is increased.

The composition comprises the higher molecular weight component (HMW component) and the lower molecular weight component (LMW component). In an illustrative pilot plant process for making the bimodal polyethylene polymer, a fluidized bed, gas-phase polymerization reactor (“FB-GPP reactor”) having a reaction zone dimensioned as 304.8 mm (twelve inch) internal diameter and a 2.4384 meter (8 feet) in straight-side height and containing a fluidized bed of granules of the composition. Configure the FB-GPP reactor with a recycle gas line for flowing a recycle gas stream. Fit the FB-GPP reactor with gas feed inlets and polymer product outlet. Introduce gaseous feed streams of ethylene and hydrogen together with 1-alkene comonomer (e.g., 1-hexene) below the FB-GPP reactor bed into the recycle gas line. Measure the (C₅-C₂₀)alkane(s) total concentration in the gas/vapor effluent by sampling the gas/vapor effluent in the recycle gas line. Return the gas/vapor effluent (other than a small portion removed for sampling) to the FB-GPP reactor via the recycle gas line.

Polymerization operating conditions are any variable or combination of variables that may affect a polymerization reaction in the GPP reactor or a composition or property of a bimodal polyethylene copolymer made thereby. The variables may include reactor design and size, catalyst composition and amount; reactant composition and amount; molar ratio of two different reactants; presence or absence of feed gases such as H₂ and/or O₂, molar ratio of feed gases versus reactants, absence or concentration of interfering materials (e.g., H₂O), average polymer residence time in the reactor, partial pressures of constituents, feed rates of monomers, reactor bed temperature (e.g., fluidized bed temperature), nature or sequence of process steps, time periods for transitioning between steps. Variables other than that/those being described or changed by the method or use may be kept constant.

In operating the method, control individual flow rates of ethylene (“C₂”), 1-alkene (“C_{X}”, e.g., 1-hexene or “C₆” or “C_{X}” wherein x is 6), and any hydrogen (“H₂”) to maintain a fixed comonomer to ethylene monomer gas molar ratio (C_{X}/C₂, e.g., C₆/C₂) equal to a described value, a constant hydrogen to ethylene gas molar ratio (“H₂/C₂”) equal to a described value, and a constant ethylene (“C₂”) partial pressure equal to a described value (e.g., 1,000 kPa). Measure concentrations of gases by an in-line gas chromatograph to understand and maintain composition in the recycle gas stream. Maintain a reacting bed of growing polymer particles in a fluidized state by continuously flowing a make-up feed and recycle gas through the reaction zone. Use a superficial gas velocity of 0.49 to 0.67 meter per second (m/sec) (1.6 to 2.2 feet per second (ft/sec)). Operate the FB-GPP reactor at a total pressure of about 2344 to about 2413 kilopascals (kPa) (about 340 to about 350 pounds per square inch-gauge (psig)) and at a described reactor bed temperature RBT. Maintain the fluidized bed at a constant height by withdrawing a portion of the bed at a rate equal to the rate of production of particulate form of the bimodal polyethylene polymer, which production rate may be from 10 to 20 kilograms per hour (kg/hr), alternatively 13 to 18 kg/hr. Remove the produced bimodal poly(ethylene-co-1-alkene) copolymer semi-continuously via a series of valves into a fixed volume chamber, and purge the removed composition with a stream of humidified nitrogen (N₂) gas to remove entrained hydrocarbons and deactivate any trace quantities of residual catalysts.

The bimodal catalyst system may be fed into the polymerization reactor(s) in “dry mode” or “wet mode”, alternatively dry mode, alternatively wet mode. The dry mode is a dry powder or granules. The wet mode is a suspension in an inert liquid such as mineral oil or the (C₅-C₂₀)alkane(s). In some aspects the composition is made by contacting the metal-ligand complex of formula (I) and the single-site non-metallocene catalyst with at least one activator in situ in the GPP reactor in the presence of olefin monomer and comonomer (e.g., ethylene and 1-alkene) and growing polymer chains. These embodiments may be referred to herein as in situ-contacting embodiments. In other aspects the metal-ligand complex of formula (I), the single-site non-metallocene catalyst, and the at least one activator are pre-mixed together for a period of time to make an activated bimodal catalyst system, and then the activated bimodal catalyst system is injected into the GPP reactor, where it contacts the olefin monomer and growing polymer chains. These latter embodiments pre-contact the metal-ligand complex of formula (I), the single-site non-metallocene catalyst, and the at least one activator together in the absence of olefin monomer (e.g., in absence of ethylene and alpha-olefin) and growing polymer chains, i.e., in an inert environment, and are referred to herein as pre-contacting embodiments. The pre-mixing period of time of the pre-contacting embodiments may be from 1 second to 10 minutes, alternatively from 30 seconds to 5 minutes, alternatively from 30 seconds to 2 minutes. The ICA may be fed separately into the FB-GPP reactor or as part of a mixture also containing the bimodal catalyst system. The ICA may be a (C₁₁-C₂₀)alkane, alternatively a (C₅-C₁₀)alkane, alternatively a (C₅)alkane, e.g., pentane or 2-methylbutane; a hexane; a heptane; an octane; a nonane; a decane; or a combination of any two or more thereof. The aspects of the polymerization method that use the ICA may be referred to as being an induced condensing mode operation (ICMO). ICMO is described in U.S. Pat. Nos. 4,453,399; 4,588,790; 4,994,534; 5,352,749; 5,462,999; and 6,489,408. The concentration of ICA in the reactor is measured indirectly as total concentration of vented ICA in recycle line using gas chromatography by calibrating peak area percent to mole percent (mol %) with a gas mixture standard of known concentrations of ad rem gas phase components.

The method uses a gas-phase polymerization (GPP) reactor, such as a stirred-bed gas phase polymerization reactor (SB-GPP reactor) or a fluidized-bed gas-phase polymerization reactor (FB-GPP reactor), to make the composition disclosed herein. Such gas phase polymerization reactors and methods are generally well-known in the art. For example, the FB-GPP reactor/method may be as described in U.S. Pat. Nos. 3,709,853; 4,003,712; 4,011,382; 4,302,566; 4,543,399; 4,882,400; 5,352,749; 5,541,270; EP-A-0 802 202; and Belgian Patent No. 839,380. These SB-GPP and FB-GPP polymerization reactors and processes either mechanically agitate or fluidize by continuous flow of gaseous monomer and diluent the polymerization medium inside the reactor, respectively. Other useful reactors/processes contemplated include series or multistage polymerization processes such as described in U.S. Pat. Nos. 5,627,242; 5,665,818; 5,677,375; EP-A-0 794 200; EP-B1-0 649 992; EP-A-0 802 202; and EP-B-634421.

The polymerization conditions may further include one or more additives such as a chain transfer agent or a promoter. The chain transfer agents are well known and may be alkyl metal such as diethyl zinc. Promoters are known such as in U.S. Pat. No. 4,988,783 and may include chloroform, CFCl₃, trichloroethane, and difluorotetrachloroethane. Prior to reactor start up, a scavenging agent may be used to react with moisture and during reactor transitions a scavenging agent may be used to react with excess activator. Scavenging agents may be a trialkylaluminum. Gas phase polymerizations may be operated free of (not deliberately added) scavenging agents. The polymerization conditions for gas phase polymerization reactor/method may further include an amount (e.g., 0.5 to 200 ppm based on all feeds into reactor) of a static control agent and/or a continuity additive such as aluminum stearate or polyethyleneimine. The static control agent may be added to the FB-GPP reactor to inhibit formation or buildup of static charge therein.

The method may use a pilot scale fluidized bed gas phase polymerization reactor (Pilot Reactor) that comprises a reactor vessel containing a fluidized bed of a powder of the bimodal polyethylene polymer, and a distributor plate disposed above a bottom head, and defining a bottom gas inlet, and having an expanded section, or cyclone system, at the top of the reactor vessel to decrease amount of resin fines that may escape from the fluidized bed. The expanded section defines a gas outlet. The Pilot Reactor further comprises a compressor blower of sufficient power to continuously cycle or loop gas around from out of the gas outlet in the expanded section in the top of the reactor vessel down to and into the bottom gas inlet of the Pilot Reactor and through the distributor plate and fluidized bed. The Pilot Reactor further comprises a cooling system to remove heat of polymerization and maintain the fluidized bed at a target temperature. Compositions of gases such as ethylene, 1-alkene (e.g., 1-hexene), and hydrogen being fed into the Pilot Reactor are monitored by an in-line gas chromatograph in the cycle loop in order to maintain specific concentrations thereof that define and enable control of polymer properties. The bimodal catalyst system may be fed as a slurry or dry powder into the Pilot Reactor from high pressure devices, wherein the slurry is fed via a syringe pump and the dry powder is fed via a metered disk. The bimodal catalyst system typically enters the fluidized bed in the lower ⅓ of its bed height. The Pilot Reactor further comprises a way of weighing the fluidized bed and isolation ports (Product Discharge System) for discharging the powder of bimodal polyethylene polymer from the reactor vessel in response to an increase of the fluidized bed weight as polymerization reaction proceeds.

In some embodiments the FB-GPP reactor is a commercial scale reactor such as a UNIPOL™ reactor, which is available from Univation Technologies, LLC, a subsidiary of The Dow Chemical Company, Midland, Michigan, USA. In some embodiments, the bimodal catalyst system used in the method consists essentially of the metallocene catalyst and the bis((alkyl-substituted phenylamido)ethyl)amine ZrR¹₂ catalyst, and, optionally, the host material; wherein the host material, when present, is selected from the at least one of the inert hydrocarbon liquid and the solid support; wherein the metallocene catalyst is an activation reaction product of contacting an activator with a metal-ligand complex of formula (I) described earlier; and wherein the bis((alkyl-substituted phenylamido)ethyl)amine catalyst is an activation reaction product of contacting an activator with the bis((alkyl-substituted phenylamido)ethyl)amine ZrR¹₂ catalyst described earlier. The phrase consists essentially of means that the bimodal catalyst system and method using same is free of a third single-site catalyst (e.g., a different metallocene, a different amine catalyst, or a biphenylphenolic catalyst) and free of non-single site catalysts (e.g., free of Ziegler-Natta or chromium catalysts). The bimodal catalyst system may also consist essentially of the host material and/or at least one activator species, which is a by-product of reacting the metallocene catalyst or non-metallocene molecular catalyst with the activator(s).

Without being bound by theory, it is believed that the bis((alkyl-substituted phenylamido)ethyl)amine catalyst (e.g., the bis(2-(pentamethylphenylamido)ethyl)amine zirconium dibenzyl) is a substantially single-site non-metallocene catalyst that is effective for making the HMW component of the bimodal poly(ethylene-co-1-alkene) copolymer and the metallocene catalyst (made from the metal-ligand complex of formula (I)) is a substantially single-site catalyst that is independently effective for making the LMW component of the composition. The molar ratio of the two catalysts of the bimodal catalyst system may be based on the molar ratio of their respective catalytic metal atom (M, e.g., Zr) contents, which may be calculated from ingredient weights thereof or may be analytically measured. The molar ratio of the two catalysts may be varied in the polymerization method by way of using a different bimodal catalyst system formulation having different molar ratio thereof or by using a same bimodal catalyst system and the trim catalyst. Varying the molar ratio of the two catalysts during the polymerization method may be used to vary the particular properties of the bimodal poly(ethylene-co-1-alkene) copolymer within the limits of the described features thereof.

The catalysts of the bimodal catalyst system may be unsupported when contacted with an activator, which may be the same or different for the different catalysts. Alternatively, the catalysts may be disposed by spray-drying onto a solid support material prior to being contacted with the activator(s). The solid support material may be uncalcined or calcined prior to being contacted with the catalysts. The solid support material may be a hydrophobic fumed silica (e.g., a fumed silica treated with dimethyldichlorosilane). The bimodal (unsupported or supported) catalyst system may be in the form of a powdery, free-flowing particulate solid. Support material. The support material may be an inorganic oxide material. The terms “support” and “support material” are the same as used herein and refer to a porous inorganic substance or organic substance. In some embodiments, desirable support materials may be inorganic oxides that include Group 2, 3, 4, 5, 13 or 14 oxides, alternatively Group 13 or 14 atoms. Examples of inorganic oxide-type support materials are silica, alumina, titania, zirconia, thoria, and mixtures of any two or more of such inorganic oxides. Examples of such mixtures are silica-chromium, silica-alumina, and silica-titania.

The inorganic oxide support material is porous and has variable surface area, pore volume, and average particle size. In some embodiments, the surface area is from 50 to 1000 square meter per gram (m²/g) and the average particle size is from 20 to 300 micrometers (μm). Alternatively, the pore volume is from 0.5 to 6.0 cubic centimeters per gram (cm³/g) and the surface area is from 200 to 600 m²/g. Alternatively, the pore volume is from 1.1 to 1.8 cm³/g and the surface area is from 245 to 375 m²/g. Alternatively, the pore volume is from 2.4 to 3.7 cm³/g and the surface area is from 410 to 620 m²/g. Alternatively, the pore volume is from 0.9 to 1.4 cm³/g and the surface area is from 390 to 590 m²/g. Each of the above properties are measured using conventional techniques known in the art.

The support material may comprise silica, alternatively amorphous silica (not quartz), alternatively a high surface area amorphous silica (e.g., from 500 to 1000 m²/g). Such silicas are commercially available from several sources including the Davison Chemical Division of W.R. Grace and Company (e.g., Davison 952 and Davison 955 products), and PQ Corporation (e.g., ES70 product). The silica may be in the form of spherical particles, which are obtained by a spray-drying process. Alternatively, MS3050 product is a silica from PQ Corporation that is not spray-dried. As procured, these silicas are not calcined (i.e., not dehydrated). Silica that is calcined prior to purchase may also be used as the support material.

Prior to being contacted with a catalyst, the support material may be pre-treated by heating the support material in air to give a calcined support material. The pre-treating comprises heating the support material at a peak temperature from 350° to 850° C., alternatively from 400° to 800° C., alternatively from 400° to 700° C., alternatively from 500° to 650° C. and for a time period from 2 to 24 hours, alternatively from 4 to 16 hours, alternatively from 8 to 12 hours, alternatively from 1 to 4 hours, thereby making a calcined support material. The support material may be a calcined support material.

The method may further employ a trim catalyst. The trim catalyst may be any one of the aforementioned metallocene catalysts made from the metal-ligand complex of formula (I) and activator. For convenience the trim catalyst is fed in solution in a hydrocarbon solvent (e.g., mineral oil or heptane). The hydrocarbon solvent may be the ICA. The trim catalyst may be made from the same metal-ligand complex of formula (I) as that used to make the metallocene catalyst of the bimodal catalyst system, alternatively the trim catalyst may be made from a different metal-ligand complex of formula (I) than that used to make the metallocene catalyst of the bimodal catalyst system. The trim catalyst may be used to vary, within limits, the amount of the metallocene catalyst used in the method relative to the amount of the single-site non-metallocene catalyst of the bimodal catalyst system. Each catalyst of the bimodal catalyst system is activated by contacting it with an activator. Any activator may be the same or different as another and independently may be a Lewis acid, a non-coordinating ionic activator, or an ionizing activator, or a Lewis base, an alkylaluminum, or an alkylaluminoxane (alkylalumoxane). The alkylaluminum may be a trialkylaluminum, alkylaluminum halide, or alkylaluminum alkoxide (diethylaluminum ethoxide). The trialkylaluminum may be trimethylaluminum, triethylaluminum (“TEAl”), tripropylaluminum, or tris(2-methylpropyl)aluminum. The alkylaluminum halide may be diethylaluminum chloride. The alkylaluminum alkoxide may be diethylaluminum ethoxide. The alkylaluminoxane may be a methylaluminoxane (MAO), ethylaluminoxane, 2-methylpropyl-aluminoxane, or a modified methylaluminoxane (MMAO). Each alkyl of the alkylaluminum or alkylaluminoxane independently may be a (C₁-C₇)alkyl, alternatively a (C₁-C₆)alkyl, alternatively a (C₁-C₄)alkyl. The molar ratio of activator's metal (Al) to a particular catalyst compound's metal (catalytic metal, e.g., Zr) may be 1000:1 to 0.5:1, alternatively 300:1 to 1:1, alternatively 150:1 to 1:1. Suitable activators are commercially available.

Once the activator and the catalysts of the bimodal catalyst system contact each other, the catalysts of the bimodal catalyst system are activated and activator species may be made in situ. The activator species may have a different structure or composition than the catalyst and activator from which it is derived and may be a by-product of the activation of the catalyst or may be a derivative of the by-product. The corresponding activator species may be a derivative of the Lewis acid, non-coordinating ionic activator, ionizing activator, Lewis base, alkylaluminum, or alkylaluminoxane, respectively. An example of the derivative of the by-product is a methylaluminoxane species that is formed by devolatilizing during spray-drying of a bimodal catalyst system made with methylaluminoxane.

Each contacting step between activator and catalyst independently may be done either in a separate vessel outside the GPP reactor (e.g., outside the FB-GPP reactor) or in a feed line to the GPP reactor. In option (a) the bimodal catalyst system, once its catalysts are activated, may be fed into the GPP reactor as a dry powder, alternatively as a slurry in a non-polar, aprotic (hydrocarbon) solvent. The activator(s) may be fed into the reactor in “wet mode” in the form of a solution thereof in an inert liquid such as mineral oil or toluene, in slurry mode as a suspension, or in dry mode as a powder. Each contacting step may be done at the same or different times.

### Test Methods

Density—Density measurements are in accordance with ASTM D792, Method B. Density is reported in grams per cubic centimeter (g/cc or g/cm³).

Melt Index (I₂, I₅, I₂₁)—Melt indices are measured in accordance with ASTM D1238, Method B, at 190° C. Data are reported as g/10 min or dg/min. Samples can be run with loads of 21.6 kg, 5.0 kg or 2.16 kg (i.e., I21, I5 or I2, respectively).

Absolute GPC (Molecular weight distribution)—The chromatographic system consisted of a PolymerChar GPC-IR (Valencia, Spain) high temperature GPC chromatograph equipped with an internal IR5 infra-red detector (IR5) and 4-capillary viscometer (DV) coupled to a Precision Detectors (Now Agilent Technologies) 2-angle laser light scattering (LS) detector Model 2040. For all absolute Light scattering measurements, the 15 degree angle is used for measurement. The autosampler oven compartment was set at 160° Celsius and the column and detector compartment were set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

In order to monitor the deviations over time, a flowrate marker (decane) was introduced into each sample via a micropump controlled with the PolymerChar GPC-IR system. This flowrate marker (FM) was used to linearly correct the pump flowrate (Flowrate (nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate (effective)) for the entire run. After calibrating the system based on a flow marker peak, the effective flowrate (with respect to the narrow standards calibration) is calculated as Equation 1. Processing of the flow marker peak was done via the PolymerChar GPCOne™ Software. Acceptable flowrate correction is such that the effective flowrate should be within +/−0.5% of the nominal flowrate.

$$Flowrate ( effective ) = Flowrate ( nominal ) * ( RV ( FM Calibrated ) / RV ( FM Sample ) ) \qquad ( EQ1 )$$

For the determination of the viscometer and light scattering detector offsets from the IR5 detector, the Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a linear homopolymer polyethylene standard (3.5>Mw/Mn>2.2) with a molecular weight in the range of 115,000 to 125,000 g/mol to the narrow standard column calibration results from the narrow standards calibration curve using PolymerChar GPCOne™ Software. The absolute molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of −0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475 (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

The absolute weight average molecular weight (MW (Abs)) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™). Other respective moments, Mn (Abs) and Mz (Abs) are be calculated according to the following equations:

$${M}_{n} ( abs ) = \frac{{Σ}^{\text{?}} {IR}_{\text{?}}}{{Σ}^{\text{?}} ( {IR}_{\text{?}} / {M}_{absolute} )}$$

$${M}_{w} ( Abs ) = \frac{{Σ}^{\text{?}} {IR}_{\text{?}} \times {{M}_{Absolute}}_{\text{?}}}{{Σ}^{\text{?}} {IR}_{\text{?}}}$$

$${M}_{\text{?}} ( Abs ) = \frac{{Σ}^{\text{?}} ( {IR}_{\text{?}} \times {{M}_{Absolute}^{2}}_{\text{?}} )}{{Σ}^{\text{?}} ( {IR}_{\text{?}} \times {{M}_{Absolute}}_{\text{?}} )}$$

$$\text{?} \text{indicates text missing or illegible when filed}$$

Complex Viscosity—Complex viscosities (q*) are calculated using Dynamic Mechanical Spectroscopy and are reported in pascal-seconds (Pa-s). Samples are compression-molded into a 9.75 inch×10.25 inch×1.85 mm thick rectangular plaque at 190° C., for 6.5 minutes, under 25,000 psi pressure, in air. The sample is then taken out of the press, and allowed to cool. The resulting plaque is subjected to a 25 mm diameter die cutter to extract disk-shaped samples for rheological testing. A constant temperature frequency sweep is performed using a TA Instruments “Advanced Rheometric Expansion System (ARES),” equipped with 25 mm (diameter) parallel plates, under a nitrogen purge. Samples are placed on the plate and allowed to melt for five minutes at 190° C. The plates are then closed to a gap of “1.8 mm,” the samples trimmed (extra sample that extends beyond the circumference of the “25 mm diameter” plate was removed), and then the tests are started. The method had an additional five minute delay built in to allow for temperature equilibrium. The tests are performed at 190° C. over a frequency range of from 0.1 radians per second (rad/s) to 100 rad/s at a constant strain amplitude of 10%.

Strain Hardening Modulus—Strain hardening modulus in MPa is measured using samples prepared by compression molding pellets according to ISO 18488:2015 (sample thickness 0.3 mm, 20 mm/min crosshead speed, test temperature 80° C.).

Pennsylvania Notch Test (PENT)—The Pennsylvania Notch Test (PENT), is performed following the procedure described by in ASTM F-1473, Standard Test Method for Notch Tensile Test to Measure the Resistance to Slow Crack Growth of Polyethlyene Pipes and Resins. The test is conducted in a temperature controlled air environment at 80° C., and using a stress of 2.4 MPa on compression molded plaques which are notched on three sides. The compression molded plaques are made using ASTM D4703, and include the additional preparation steps as required in F-1473. The compression molded plaques are cooled as detailed in the ASTM F-1473 procedure. The specimens are notched on the top and on two sides at a speed of less than 0.25 mm/min, and “perpendicular to the tensile axis of the specimen” as required in F-1473. The notch depth is approximately 35% of the sample thickness. The razor used to make the notch is 0.2 mm thick.

2% Secant Modulus—2% Secant Modulus is measured according to ASTM D790 employing specimen with 0.5″ width, 5″ length, and 0.125″ thickness. The measurement is conducted at a test speed of 0.5 inch/min. The samples used for flexural property measurement is molded according to ASTM D4706 Annex A.1 Procedure C (controlled cooling at 15° C./min). Values are reported in kilopound force per square inch (ksi). (1 Megapascal (MPa)=0.145 ksi).

Environmental Stress Crack Resistance (ESCR)—All ESCR values disclosed herein are F50 failure times reported in hours and are measured according to ASTM D1693, Method B, on compression molded samples having a thickness of 1.90 mm in a 10% Igepal solution at 50° C. Deconvolution of GPC Chromatogram—The fitting of the chromatogram into a high molecular weight (HMW) and low molecular weight (LMW) component fraction was accomplished using a Flory distribution which was broadened with a normal distribution function as follows: For the log M axis, 601 equally-spaced Log(M) points, spaced by 0.01, were established between 2 and 8 representing the molecular weight range between 100 and 100,000,000 where Log is the logarithm function to the base 10. At any given Log(M), the population of the Flory distribution was in the form of Eq. 6:

$${dW}_{f} = {( \frac{2}{{M}_{w}} )}^{3} ( \frac{{M}_{w}}{0.868588961964} ) {M}^{2} {e}^{( - 2 M / {M}_{w} )} \qquad Eq . 6$$

where Mw is the weight-average molecular weight of the Flory distribution and M is the specific x-axis molecular weight point, (10 \hat{ }[Log(M)]). The Flory distribution weight fraction was broadened at each 0.01 equally-spaced log (M) index according to a normal distribution function, of width expressed in Log(M), σ; and current M index expressed as Log(M), μ.

$${f}_{( L o gM , μ , σ )} = \frac{{e}^{- \frac{{( L o g M - μ )}^{2}}{2 {σ}^{2}}}}{σ \sqrt{2 π}} \qquad Eq . 7$$

It should be noted that before and after the spreading function has been applied that the area of the distribution (dW_{f}/d Log M) as a function of Log(M) is normalized to unity. Two weight-fraction distributions, dW_{f1} and dW_{f2}, for LMW and HMW components or components 1 and 2 were expressed with two unique Mw target values, Mw₁ and Mw₂ and with overall component compositions A₁ and A₂. Both distributions were broadened with the same width, s. The two distributions were summed as follows:

$$d {W}_{f} = {A}_{1} d {W}_{f 1} + {A}_{2} d {W}_{f 2} \qquad Eq . 8$$

where: A₁+A₂=1

The weight fraction result of the measured (from Absolute GPC) GPC molecular weight distribution was interpolated along 601 log M points using a 2nd order polynomial. Microsoft Excel™ 2010 Solver was used to minimize the sum of squares of residuals for the equally-spaces range of 601 Log M points between the interpolated chromatographically determined molecular weight distribution and the two broadened Flory distribution components (s₁ and s₂), weighted with their respective component compositions, A₁ and A₂. The iteration starting values for the components are as follows:

$$Component 1 : {Mw}_{1} = 15 , 000 , s = 0.3 , and {A}_{1} = 0.475$$

$$Component 2 : {Mw}_{2} = 250 , 000 , s = 0.3 , and {A}_{2} = 1 - {A}_{1}$$

$$( Note s 1 = s 2 and {A}_{1} + {A}_{2} = 1 )$$

The bounds for components 1 and 2 are such that s is constrained such that s>0.001, yielding an Mw/Mn of approximately 2.00 and s<0.450, yielding a Mw/Mn of approximately 5.71. The composition, A₁, is constrained between 0.000 and 1.000. The Mw₁ is constrained between 2,500 and 2,000,000. The composition, A₂, is constrained between 0.000 and 1.000. The Mw₂ is constrained between 2,500 and 2,000,000. The “GRG Nonlinear” engine was selected in Excel Solver™ and precision was set at 0.00001 and convergence was set at 0.0001. The solutions were obtained after convergence (in all cases shown, the solution converged within 60 iterations).

### Examples

DOW™ TCP-2495 NT is a high density polyethylene composition commercially available from the Dow Chemical Company, and has a density of 0.946 g/cm³ and properties as specified in the below tables. This is Comparative Example 1 (CE1).

CONTINUUM™ DGDA-2488 NT is a bimodal polyethylene composition commercially available from the Dow Chemical Company and is produced in a dual reactor system using UNIPOL™ II process technology. This is Comparative Example 2 (CE2).

| | IE1 | IE2 | CE3 |
|---|---|---|---|
| Reactor Type | S, CM, FB GPP* | S, CM, FB GPP* | S, CM, FB GPP* |
| Reactor Purging gas | Anhydrous N₂ | Anhydrous N₂ | Anhydrous N₂ |
| Bed Temp. (° C.) | 95.0 | 105.0 | 86.0 |
| Rx Pressure (psig)\hat{ } | 349.4 | 349.1 | 349.6 |
| C₂ Partial Pressure (psig) | 219.4 | 217.3 | 220.0 |
| H₂/C₂ Molar Ratio | 0.0050 | 0.0047 | 0.0004 |
| C₆/C₂ Molar Ratio | 0.0072 | 0.0048 | 0.0004 |
| Superficial Gas Velocity (ft/sec) | 1.84 | 1.87 | 1.90 |
| Bimodal Catalyst System | BMC1 | BMC2 | BMC2 |
| Trim catalyst | TC1 | TC2 | TC2 |
| Starting seedbed = granular HDPE resin | Preloaded | Preloaded | Preloaded |
| Fluidized Bed Weight (lb) | 86.1 | 82.7 | 100.3 |
| Copolymer composition Production Rate | 40.1 | 36.3 | 31.7 |
| (lb/hour) | | | |
| Copolymer composition Residence Time | 2.1 | 2.3 | 3.2 |
| (hour) | | | |
| Copolymer composition Fluid Bulk | 14.6 | 13.7 | 18.2 |
| Density, (lb/ft³) | | | |

*S, CM, FB, GPP: single, continuous mode, fluidized bed gas phase polymerization. Pilot plant reactor did not operate in condensing mode. \hat{ }Rx Pressure (kPa): reactor total pressure in kilopascals.
Bimodal Catalyst System 1 (BMC1): a spray-dried catalyst formulation prepared from Cabosil ™ TS-610, methylalumoxane, bis(2-(pentamethylphenylamido)ethyl)-amine zirconium dibenzyl, and (methylcyclopentadienyl)(1,3-dimethyl-4,5,6,7-tetrahydroindenyl)zirconium dimethyl.
Bimodal Catalyst System 2 (BMC2): a spray-dried catalyst formulation prepared from Cabosil ™ TS-610, methylalumoxane, bis(2-(pentamethylphenylamido)ethyl)-amine zirconium dibenzyl, and (cyclopentadienyl)(1,5-dimethylindenyl)zirconium dimethyl.
Trim catalyst 1 (TC1): a solution of 0.04 wt % (methylcyclopentadienyl)(1,3-dimethyl-4,5,6,7-tetrahydroindenyl)zirconium dimethyl in isopentane. Trim catalyst 2 (TC2): a solution of 0.04 wt % (cyclopentadienyl)(1,5-dimethylindenyl)zirconium dimethyl in isopentane.

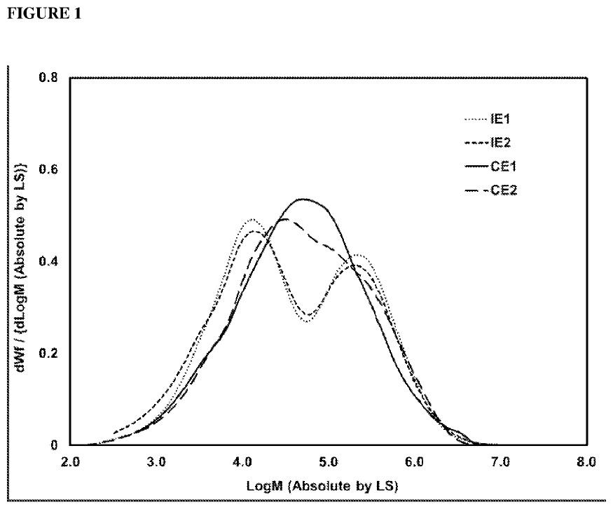

As supported by the below and above, the composition according to embodiments disclosed herein can be made in a single reactor, can be easily processed due to their viscosity and melt index profiles, and can provide a desirable balance of properties such as flexibility, stiffness, and ESCR in comparison to the comparative examples. While Comparative Example 2 exhibits comparable PENT and ESCR properties, it has a significantly different molecular weight profile and cannot be made in a single reactor system due to its catalyst system, among other things. FIG. 1 depicts the absolute GPC curve of comparative and inventive examples. The Mmax1 and Mmax2 values in Table 1 for IE 1 and IE2 relate to the peaks in the absolute GPC curve. Mmax1 is for the lower M peak and Mmax2 is for the higher M peak.

TABLE 1
Properties of Compositions 1 and 2

| | IE 1 | IE 2 |
|---|---|---|
| Modality | Bimodal | Bimodal |
| Density (g/cm³) | 0.953 | 0.953 |
| I2 (g/10 min) | 0.23 | 0.32 |
| I5 (g/10 min) | 0.85 | 1.12 |
| I21 (g/10 min) | 22.4 | 32.7 |
| MFR - I21/I2 | 96 | 102 |
| MFR - I21/I5 | 26 | 29 |
| Mn (g/mol) | 8,672 | 7,377 |
| Mw (g/mol) | 188,802 | 186,487 |
| Mz (g/mol) | 1,152,708 | 1,176,636 |
| Mw/Mn | 21.8 | 25.3 |
| Mz/Mw | 6.1 | 6.3 |
| Mmax1 (g/mol) | 13,182 | 13,804 |
| Mmax2 (g/mol) | 218,791 | 204,186 |
| Viscosity - V.01 (Pas) | 38,576 | 32,140 |
| Viscosity - V100 (Pas) | 1,868 | 1,583 |
| Shear Thinning Ratio | 20.7 | 20.3 |
| 2% Secant Modulus (ksi) | 132 | 140 |
| Strain Hardening Modulus (MPa) | 49.06 | 35.69 |
| PENT (hours) | 660.2 | 51.6 |
| ESCR (hours) | >1000 | >1000 |
| HMW Component wt % | 49% | 43% |
| LMW Component wt % | 51% | 57% |
| HMW Mw (g/mol) | 356,726 | 374,064 |
| HMW Mn (g/mol) | 98,276 | 107,933 |
| HMW Mz (g/mol) | 957,353 | 961,388 |
| LMW Mw (g/mol) | 15,830 | 20,642 |
| LMW Mn (g/mol) | 5,214 | 4,510 |
| LMW Mz (g/mol) | 37,162 | 74,703 |

TABLE 2
Properties of Comparative Compositions

| | CE 1 | CE 2 | CE 3 |
|---|---|---|---|
| Modality | Unimodal | Bimodal | Bimodal |
| Density (g/cm³) | 0.946 | 0.955 | 0.958 |
| I2 (g/10 min) | 0.18 | 0.27 | 0.18 |
| I5 (g/10 min) | 0.99 | 1.08 | 1.28 |
| I21 (g/10 min) | 21.8 | 26.7 | 29.9 |
| MFR - I21/I2 | 121 | 99 | 166 |
| MFR - I21/I5 | 22 | 25 | 23.3 |
| Mn (g/mol) | 12,019 | 10,251 | 22,733 |
| Mw (g/mol) | 174,207 | 182,727 | 266,554 |
| Mz (g/mol) | 1,072,418 | 865,000 | 2,088,078 |
| Mw/Mn | 14.5 | 17.8 | 11.7 |
| Mz/Mw | 6.2 | 4.7 | 7.8 |
| Viscosity - V.01 (Pas) | 47,533 | 36,234 | 75,636 |
| Viscosity - V100 (Pas) | 1,557 | 1,680 | 1,364 |
| Shear Thinning Ratio | 30.5 | 21.6 | 55.5 |
| 2% Secant Modulus (ksi) | 125 | 155 | 165 |
| Strain Hardening | 29.94 | 37.3 | 15.9 |
| Modulus (MPa) | | | |
| PENT (hours) | 21.5 | 60.2 | Not Measured |
| ESCR (hours) | 893 | >1000 | 165 |
| HMW Component wt % | — | — | 22% |
| LMW Component wt % | — | — | 78% |

### Pipe Extrusion and Testing

Pipes are formed from IE2, CE1, and CE2. The pipes are tested for hydrostatic burst testing. The pipes are 1″ IPS (Iron Pipe Size) SDR11 (Standard Diameter Ratio). To form the pipes, pellets are added to the feed hopper of the American Maplan 60 mm groove feed pipe extrusion line (L/D=30/1). The pipe specimens are extruded to an outside diameter (OD) and wall thickness tolerances per ASTM D 3035. Pipe dimensions are measured per ASTM D 2122. The outer diameter is measured using a calibrated pi tape. The wall thickness is measured using a calibrated micrometer. Hydrostatic testing is conducted according to ASTM D1598 at 73° F. (23° C.). Pipe extrusion conditions and final dimensions are in Table 3 below.

TABLE 3
Pipe Extrusion Conditions and Final Dimensions

| Resin | IE2 | CE1 | CE2 |
|---|---|---|---|
| Modality | Bimodal | Unimodal | Bimodal |
| Zone Temps (F.) | | | |
| Die 1 | 390 | 390 | 390 |
| 2 | 390 | 390 | 390 |
| 3 | 390 | 390 | 390 |
| 4 | 390 | 390 | 390 |
| 5 | 390 | 390 | 390 |
| 6 | 390 | 390 | 390 |
| 7 | 390 | 390 | 390 |
| 8 | 390 | 390 | 390 |
| Barrel 1 | 370 | 370 | 370 |
| 2 | 380 | 380 | 380 |
| 3 | 390 | 390 | 390 |
| 4 | 390 | 390 | 390 |
| Melt (probe) (F.) | 284 | 301 | 293 |
| Barrel Press. (psi) | 1608 | 1665 | 1703 |
| Screw RPM | 49.5 | 51.4 | 47.8 |
| Motor Amps (%) | 81 | 87 | 86 |
| Puller Speed (ft/min) | 28.1 | 27.65 | 27.65 |
| Rate (lbs/h) | 302.4 | 301.9 | 302.1 |
| Specific Rate (lb/h/rpm) | 6.11 | 5.87 | 6.32 |
| Specific Energy Input (J/g) | 548 | 570 | 530 |
| Melt Temp Die Exit (F.) | 422 | 428 | 428 |
| Pipe OD (in) | 1.304 | 1.312 | 1.306 |
| Pipe Wall Thickness Range | 0.123-0.128 | 0.124-0.129 | 0.126-0.129 |
| (in) | | | |

1. A pipe comprising a multimodal high density polyethylene composition, the multimodal high density polyethylene composition comprising greater than 40 wt. % of a high molecular weight component and less than 60 wt. % of a low molecular weight component, based on the total weight of the multimodal high density polyethylene composition, wherein the multimodal high density polyethylene composition has:
a. a density greater than 0.950 g/cm³;
b. a high load melt index (I₂₁) of from 20.0 to 35.0 g/10 min;
c. a viscosity at 0.1 rad/sec of greater than 30,000 Pas;
d. a shear thinning ratio of from 15.0 to 25.0;
e. a PENT value greater than 30 hours;
f. a strain hardening modulus of greater than 30.00 MPa; and
g. a Mz/Mw of greater than 5.5.

2. The pipe according to claim 1, wherein the composition has a molecular weight distribution from Absolute GPC, where the Absolute GPC molecular weight distribution has a first peak, a local minimum, and a second peak in a range of Log(molecular weight) of 3.5 to 6.0, wherein the local minimum is an inflection point between the first peak and the second peak, and the first peak corresponds to the low molecular weight component and the second peak corresponds to the high molecular weight component.

3. The pipe of claim 1, wherein the composition has a I₂₁/I₅ ratio of from 25 to 35.

4. The pipe of claim 1, wherein the composition has a Mw/Mn of from 20 to 30.

5. The pipe of claim 1, wherein the composition has a weight average molecular weight (Mw) of greater than 175,000 g/mol.

6. The pipe of claim 1, wherein the composition has a melt index (I₂) of from 0.20 to 0.40 g/10 min.

7. The pipe of claim 1, wherein the composition has a I₂₁/I₂ ratio of from 90 to 110.

8. The pipe of claim 1, wherein the composition has a secant modulus at 2% of greater than 130 ksi.

9. The pipe of claim 1, wherein the composition has an ESCR value of greater than 1,000 hours.

10. The pipe of claim 1, wherein the composition is made by the process of polymerizing ethylene and an alpha-olefin in the presence of a bimodal catalyst system in a single gas phase polymerization (GPP).

11. A process for making a pipe comprising forming the multimodal high density polyethylene composition in claim 1 and extruding the multimodal high density polyethylene composition to form a pipe, wherein the multimodal high density polyethylene is formed by polymerizing ethylene monomer and an alpha-olefin comonomer in the presence of a bimodal catalyst system in a single gas phase polymerization (GPP); wherein the bimodal catalyst system consists essentially of a metallocene catalyst, a single-site non-metallocene catalyst that is a bis((alkyl-substituted phenylamido)ethyl)amine catalyst, optionally a host material, and optionally an activator; wherein the host material, when present, is selected from at least one of an inert hydrocarbon liquid and a solid support; wherein the metallocene catalyst is an activation reaction product of contacting an activator with a metal-ligand complex of formula (R1-2Cp)((alkyl)1-3Indenyl)MX2, wherein R is hydrogen, methyl, or ethyl; each alkyl independently is a (C1-C4)alkyl; M is titanium, zirconium, or hafnium; and each X is independently a halide, a (C1 to C20)alkyl, a (C7 to C20)aralkyl, a (C1 to C6)alkyl-substituted (C6 to C12)aryl, or a (C1 to C6)alkyl-substituted benzyl; and wherein the bis((alkyl-substituted phenylamido)ethyl)amine catalyst is an activation reaction product of contacting an activator with a bis((alkyl-substituted phenylamido)ethyl)amine ZrR12, wherein each R1 is independently selected from F, Cl, Br, I, benzyl, —CH2Si(CH3)3, a (C1-C5)alkyl, and a (C2-C5)alkenyl.
